(19) United States
(12) Patent Application Publication
(10) Pub. No.: US 2007/0158459 A1
(43) Pub. Date: Jul. 12, 2007

(54) Spray generation using a vibrating surface

(76) Inventors: Sattar Motedayan Aval, Greater Manchester (GB); Susan Michelle Kutay, Port Moody (CA); Andrew John Yule, Manchester (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/550,777

(22) PCT Filed: Mar. 17, 2004
(86) PCT No.: PCT/EP04/02833

§ 371 Date: Sep. 18, 2006

(30) Foreign Application Priority Data
Mar. 27, 2003 (GB) 0307055.4

(51) Int. Cl. B05B 17/04; B05B 1/08; B05B 1/26

(52) U.S. Cl. 239/102.1; 239/11; 239/601

(57) ABSTRACT

A method of generating a spray comprising subjecting a liquid on a continuous atomisation surface (1) to acoustic vibration, characterised in that the continuous atomisation surface (1) comprises multiple hollows from which the liquid is atomised.

### FIELD OF THE INVENTION

The present invention is in the field of spray technology, in particular, spray technology utilising atomisation from a vibrating surface. The invention relates to a method of producing a high quality spray via atomisation from particular vibrating surfaces; also disclosed are spray devices incorporating such surfaces.

### BACKGROUND

Spray devices utilising atomisation from a vibrating surface are known in the art. Such devices may utilise ultrasonic vibrational frequencies and may be used, for example, as nebulizers and asthma inhalers. U.S. Pat. No. 4,702,418 (Carter) discloses the use of an ultrasonic piezoelectric vibrator to generate acoustic vibration. U.S. Pat. No. 5,297,734 (Toda) discloses ultrasonic atomisation from a vibrating plate (attached to a piezoelectric vibrator), said plate having a large number of minute holes through which the liquid to be atomised passes. WO 00/47335 (S. C. Johnson and Son) describes such an atomisation surface as an orifice plate. WO 5,299,739 (TDK Corp.) discloses an atomisation surface with a mesh located in close proximity. Similarly, U.S. Pat. No. 4,796,807 (Lechler GmbH & C. KG) discloses an atomiser comprising an ultrasonic atomising disc with a sieve-like diaphragm resting upon it.

### SUMMARY OF THE INVENTION

The present invention involves a vibrating atomisation surface that has a particular design. It enables high quality atomisation to be effectively and efficiently achieved; in particular, it enables operation at relatively low frequencies, thereby reducing the power requirement. Spray devices incorporating such vibrating atomisation surfaces can have numerous benefits, including being easily portable, potentially battery powered, capable of long periods of use, and producing good quality sprays.

In a first aspect of the present invention, there is provided a method of generating a spray comprising subjecting a liquid on a continuous atomisation surface to acoustic vibration, characterised in that the continuous atomisation surface comprises multiple hollows from which the liquid is atomised.

In a second aspect of the present invention, there is provided a spray device comprising a continuous atomisation surface, a reservoir for holding the liquid to be atomised, means for transferring the liquid from the reservoir to the atomisation surface, and means for subjecting the continuous atomisation surface to acoustic vibration, characterised in that the continuous atomisation surface comprises multiple hollows from which the liquid is atomised.

In a third aspect of the present invention, there is provided a product comprising a spray device according to the second aspect of the invention and a liquid composition for spraying therefrom.

### DETAILED DESCRIPTION

Throughout this specification, the term “acoustic vibration” should be understand to refer to vibration at frequencies across the across the range of the acoustic spectrum. The acoustic vibration used according to the invention is typically at a frequency of from 1 KHz to 100 KHz, in particular from 2 KHz to 55 KHz, and especially from 5 KHz to 40 KHz. Low range ultrasonic frequencies are particularly preferred, typically values being from 20 to 55 KHz and especially from 20 to 40 KHz.

The novel atomisation surface used as part of the present invention comprises multiple hollows and is continuous, meaning that the atomisation surface comprises no gaps between elements making up the surface and its multiple hollows. Elements making up the surface may comprise walls and a base, in which case the walls are attached to the base and are preferably integral therewith.

In many embodiments, the underlying shape of the atomisation surface is planar, although other shapes such as frusto-conical are possible. The underlying shape of the atomisation surface may be thought of as the surface comprising all of the lowest points of the hollows. When the underlying shape of the atomisation surface is planar, the plane may be orthogonal to the acoustic vibration used to create atomisation.

For maximum efficiency of space, it is preferred that the continuous atomisation surface comprises multiple hollows covering 50% or greater, in particular 90% or greater of its area.

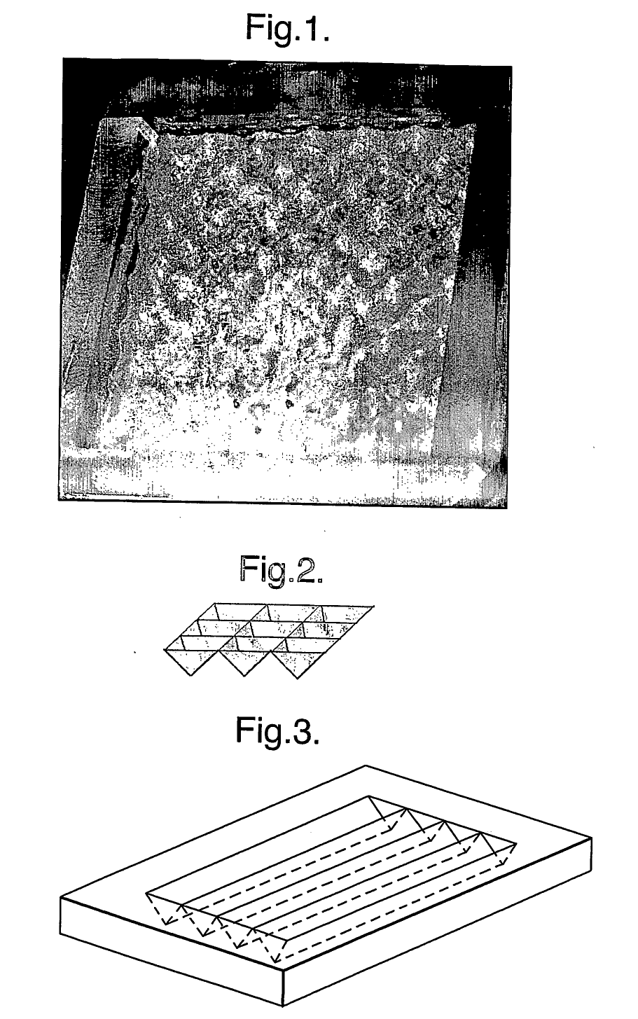

The continuous atomisation surface may take the form of a cusp surface in which the surface comprises both multiple hollows and multiple peaks. An example is the cusp surface illustrated in FIG. 1.

The continuous atomisation surface may comprise hollows having planar sloping sides. The sloping sides may meet at a line or a point at the bottom of the hollow. An example of the latter are hollows having the form of inverted pyramids, as illustrated in FIG. 2. An example of the former are hollows having the form of V-shaped grooves, as illustrated in FIG. 3.

In many embodiments the continuous atomisation surface may comprise hollows each having walls and a base. Preferably the hollows each have the same depth. For ease of manufacture, it is preferred that the bases are flat, although curved bottoms may be possible. Also for ease of manufacture, it is preferred that the walls are perpendicular to the base. It is particularly preferred that the hollows have flat bottoms, walls perpendicular thereto, and have the same cross-sectional shape at any depth.

With regard to the preferred cross-sectional shape and maximum cross-sectional dimension of a hollow, these terms should be understood to refer to the cross-section of a hollow at its top.

Preferably, the cross-sectional shape of the hollows is such that the hollows tessellate. This is particularly useful when the hollows have flat bottoms and walls perpendicular thereto.

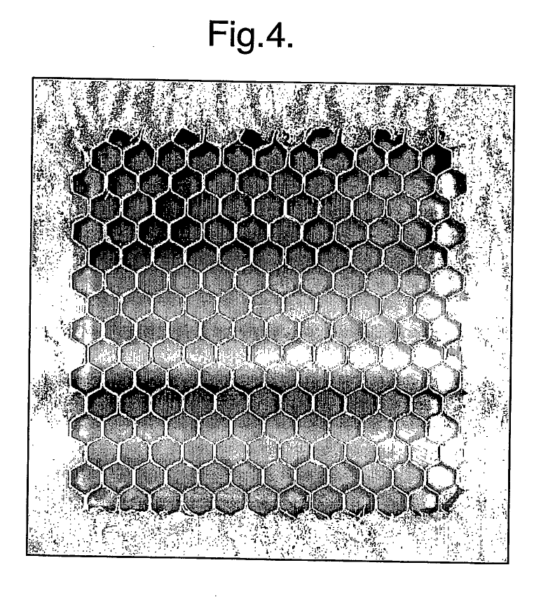

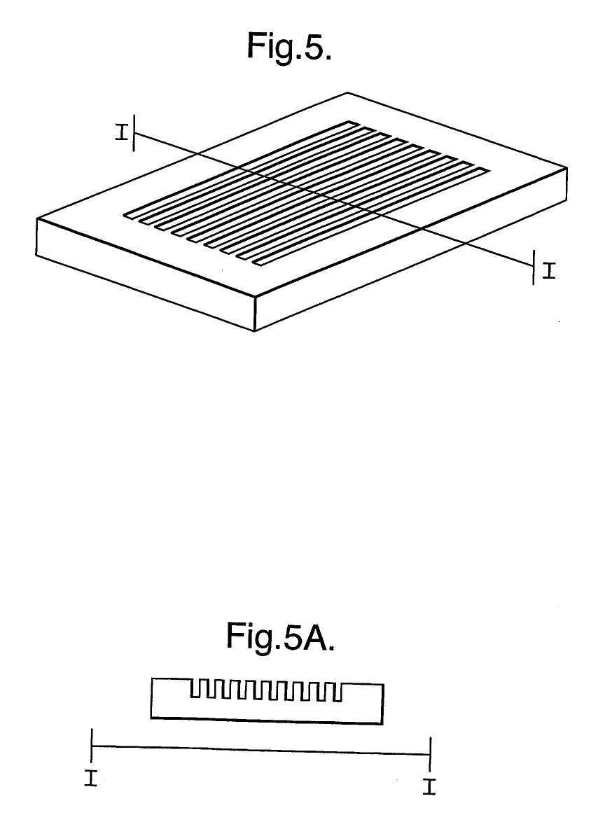

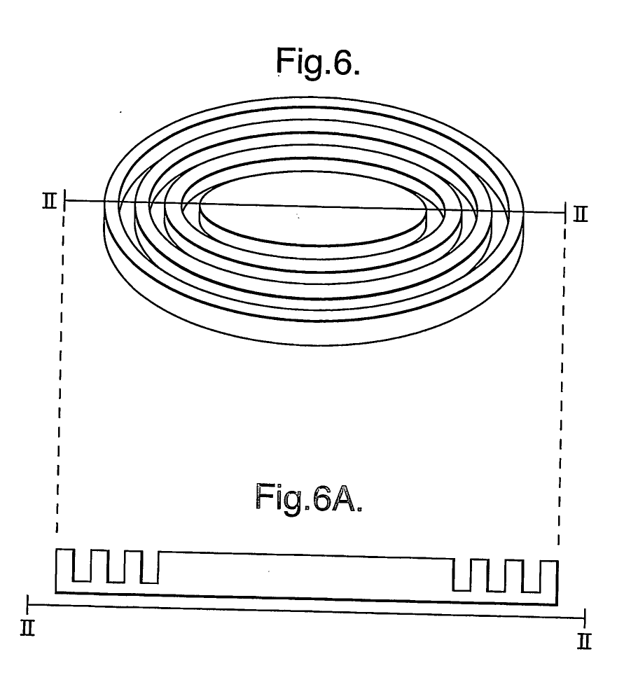

Preferred cross-sectional shapes for the hollows are triangular, square, hexagonal (as illustrated in FIG. 4), or rectangular (as illustrated in FIGS. 3, 5 and 5A). Hollows having square, hexagonal, or rectangular cross-section are particularly preferred. It is preferred that all the hollows on the continuous atomisation surface have the same cross-sectional shape.

Hollows having rectangular cross-section preferably exist in the form of a series of slots or grooves, the slots or grooves optionally being parallel, as in FIGS. 3, 5 and 5A.

The atomisation surface may comprise hollows in the form of slots or grooves having any cross-section. Such slots/grooves may be continuous or discontinuous. It is also possible for the slots/grooves to be curved. Curved, continuous slots/grooves may take a circular form, as illustrated in FIGS. 6 and 6A.

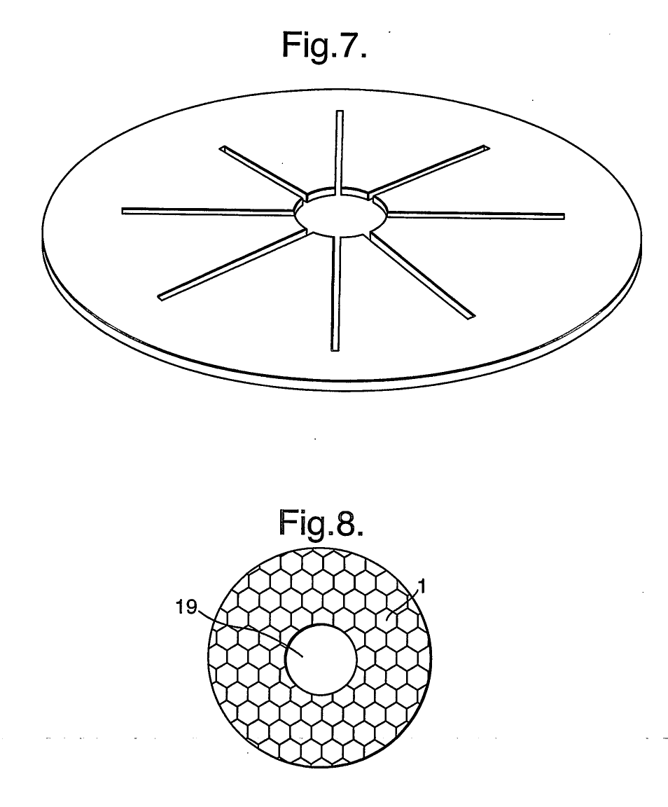

Hollows in the form of slots/grooves may radiate outward from the centre of the atomisation surface. In such embodiments, it is preferred that the atomisation surface is fed from underneath by a transfer conduit opening into its centre. The transfer conduit may feed directly into the outwardly radiating slots/grooves, as illustrated in FIG. 7 (the diameter of the transfer conduit is exaggerated in this representation).

The ratio of the depth of a hollow to the maximum cross-sectional dimension of the same hollow is generally 1:1 or greater, in particular 1:2.5 or greater. Preferably, this ratio is 20:1 or less, more preferably 10:1 or less, and especially 6.5:1 or less. Generally, this ratio is the same for all of the hollows on the atomisation surface.

The depth of each hollow is preferably 5 mm or less, in particular 2.5 mm or less, and especially 1.5 mm or less, with a preferred minimum depth of 0.05 mm, in particular 0.1 mm. The maximum cross-sectional dimension of the hollows is preferably from 0.1 mm to 6.5 mm, in particular from 0.2 mm to 3 mm, and especially from 0.5 mm to 3 mm.

During use, the hollows on the continuous atomisation surface contain the liquid to be atomised. The amount of liquid present is preferably 50% or greater, more preferably 90% or greater, and most preferably 99% or greater of the volume of the hollows.

Spray devices that operate according to the method of the invention require a reservoir for holding the liquid and a means for transferring the liquid from the reservoir to the atomisation surface. The liquid may be transferred to the atomisation surface from the top or from underneath. In many embodiments there exists a transfer conduit for transfer of the liquid from the reservoir towards the atomisation surface. The liquid may be fed onto the atomisation surface from a transfer conduit directed onto or opening into the centre of the atomisation surface, the liquid at first flowing into the hollows nearest the end of the transfer conduit of the transfer conduit and then overflowing from those into adjacent hollows and so on. An example of an atomisation surface designed for transfer of liquid, from underneath, into the centre of the surface is illustrated in FIG. 8.

When present, the transfer conduit preferably comprises one or more valves. Such valves may function to prevent leakage of the liquid from the reservoir when the device is not operating. Positive pressure on the reservoir side of the valve or negative pressure on the nozzle side of the valve may cause the opening of such valves.

The means for transferring the liquid from the reservoir to the atomisation surface may comprise a pump, for example a diaphragm pump, piston pump, or peristaltic pump. Said pump may act upon the liquid itself or may act as a compressor to pressurise gas in contact with the liquid to be transferred. Alternatively, compressed gas may be introduced into the reservoir during the manufacture of the device and used to provide the force required to transfer the liquid to the atomisation surface.

Spray devices that operate according to the method of the invention require a means for subjecting the continuous atomisation surface to acoustic vibration. Said means generally functions by being in contact with the atomisation surface. Typically, the means comprises a piezoelectric transducer mechanically coupled to an amplitude transformer, the latter element being in contact with the atomisation surface. The piezoelectric transducer may be of any of the types known in the art and serves to translate electrical energy from a battery or other such source into mechanical energy of vibration.

The battery or other source of electrical energy referred to above may be contained within the device itself, being for example a battery (disposable or rechargeable), a capacitor, or a photoelectric cell, or the source may be external, for example mains electricity. Similar sources of electrical energy may be used to power the aforementioned pump, when present, and/or a fan for aiding the flow of atomised liquid from the device towards its target (vide infra).

The means for subjecting the fluid to acoustic vibration may comprise an activation means. The activation means may be of any appropriate form. Typical examples include push buttons, toggle switches, or slide-operated switches. The activation will typically involve supply of electrical energy to the aforementioned piezoelectric transducer mechanically coupled to the amplitude transformer. A pump for transferring the fluid from the reservoir to the atomisation surface and/or a fan for aiding the flow of atomised liquid from the device towards its target (vide infra) may also be activated on use of the activation means, in the presence of appropriate circuitry.

An additional component that may be used in spraying devices according to the present invention is a means of generating airflow adjacent to the upper side of the atomisation surface. Such airflow may enhance the delivery of the spray generated from the atomisation surface. A fan is a suitable means of generating the airflow and may be incorporated into the spraying device in a manner that enables generation of airflow adjacent to the upper side of the atomisation surface. The use of a fan in an acoustic atomiser is described in U.S. Pat. No. 3,970,250 (Siemens Aktiengesellschaft). An inlet vent for air is a preferred additional feature of devices according to the present invention, in particular those also comprising a means of generating airflow adjacent to the upper side of the atomisation surface.

A spraying device according to the present invention is able to achieve high fluid output, for example from 30 ml/hr. to 500 ml/hr., and, in particular, from 45 ml/hr. to 180 ml/hr., whilst still maintaining good spray quality. Spray quality may be defined by the fineness of the droplets achieved and/or by the narrowness of the particle size distribution of said droplets. For many applications, it desirable to achieve a particle size distribution in which the D4,3 droplet volume size is from 1 μm to 150 μm, in particular from 5 μm to 100 μm, and especially from 5 μm to 25 μm. The narrowness of particle size distribution may be expressed by the “SPAN”, where SPAN is [D(90)-D(10)]/D(50). The present invention preferably operates to give a SPAN of 1.2 or less, in particular 1.0 or less, and especially 0.9 or less.

The spraying device of the present invention is preferably hand-held. The device and the method of spray generation is particularly suitable for use in the domestic environment, i.e. in the home and garden. The device may be used with numerous liquid compositions, in particular compositions for use in the domestic environment, such as cleansing and perfuming compositions. It is especially suitable for application of liquid cosmetic compositions, which are generally applied directly to the human body. Examples of such compositions include hair sprays, perfume sprays, and deodorant sprays (body sprays and underarm products, in particular antiperspirant compositions).

Surprisingly, the present invention may be used in the spraying of relatively viscous liquids and compositions. For example, it is possible to spray liquids and compositions of viscosity equal to or greater than 10 mm²/s, 100 mm²/s, or even 1000 mm²/s, particularly with the more preferred embodiments of the invention.

Liquid compositions used with the device of the present invention typically comprise a liquid carrier. The liquid carrier may comprise a C2 to C4 alcohol, for example ethanol, propylene glycol, propanol, or iso-propanol. When such liquid compositions are cosmetic compositions for application to the human body, the good spray quality attained leads to an excellent sensory benefit for the user. Suitable liquid compositions typically comprise C2 to C4 alcohol at a level of from 5% to 95%, in particular from 25% to 80%, and especially from 40% to 75% by weight of the composition. Liquid compositions comprising ethanol are particularly suitable for use with the device of the present invention.

The aforementioned liquid carrier may also comprise water in an amount from 0.1% to 99% by weight of the composition.

Embodiments according to the present invention are described more fully by way of example only and with reference to the accompanying drawings, in which:

FIG. 1 is a representation of a continuous atomisation surface having a cusp hollows;

FIG. 2 is a representation of a continuous atomisation surface having hollows with planar sloping sides meeting at a point and having the form of inverted pyramids;

FIG. 3 is a representation of a continuous atomisation surface having hollows with planar sloping sides meeting at a line and having the form of V-shaped grooves;

FIG. 4 is a representation of a continuous atomisation surface having hollows with flat bases and perpendicular sides, the hollows having a hexagonal cross-section;

FIG. 5 is a representation of a continuous atomisation surface having hollows with flat bases and perpendicular sides, the hollows having a rectangular cross-section and being in the form of a series of parallel slots;

FIG. 5A is a cross-sectional view of the embodiment represented in FIG. 5;

FIG. 6 is a representation of a continuous atomisation surface having hollows taking the form of curved, continuous slots in concentric circles;

FIG. 6A is a cross-sectional view of the embodiment represented in FIG. 6;

FIG. 7 is a representation of a continuous atomisation surface having hollows in the form of slots that radiate outward from the centre of the atomisation surface where a transfer conduit feeds directly into the outwardly radiating slots (the diameter of the transfer conduit is exaggerated in this representation);

FIG. 8 is a top view of a central portion of the embodiment represented in FIG. 8 (scale increased);

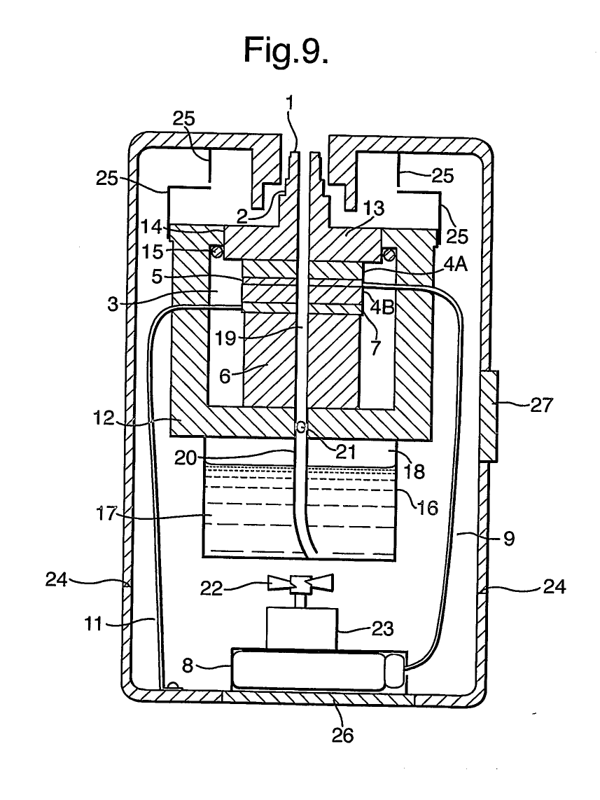

FIG. 9 is a central vertical section through a specific embodiment of a spraying device according to the present invention.

In the embodiment represented by FIG. 9, a continuous atomisation surface (1) is present on the top surface of an amplitude transformer (2), which amplifies ultrasonic vibration originating from a piezoelectric transducer (3). The piezoelectric transducer (3) comprises two annular piezoelectric discs (4A, 4B), having sandwiched between them an input electrode (5). Below the piezoelectric discs (4A, 4B) is a support block (6), with an earth electrode (7) sandwiched between the lower piezoelectric disc (4B) and the support block (6). The input electrode (5) receives power from a battery (8), via an electrical supply conduit (9) and the earth electrode (7) is earthed to an outer casing (10) via an earthing conduit (11).

Surrounding the piezoelectric discs (4A, 4B), electrodes (5, 7), and support block (6), there is an inner casing (12). The base (13) of the amplitude transformer (2) is located in the top section of the inner casing (12). A small gap (14) between these components is sealed by means of an o-ring (15). The outer casing is attached to the inner casing (12) by support members (not shown).

Beneath the inner casing (12), there is a reservoir (16) for liquid cosmetic composition (17) and compressed gas (18). A transfer conduit, in the form of a plastic tube (19), including a dip tube (20), links the reservoir (16) with the atomisation surface (1). The tube (19) delivers to the centre of the atomisation surface (1). The tube (19) passes through the centre of the device, going through the lower part of the inner casing (12), the support block (6), the earth electrode (7), the lower piezoelectric disc (4B), the input electrode (5), the upper piezoelectric disc (4A), and the amplitude transformer (2), en route to the atomisation surface (1).

An electrically operated valve (21) serves to hold the pressurised liquid (17) in the reservoir (16) until operation of the device is desired.

Beneath the reservoir (16) there is a fan (22), driven by fan motor (23). This fan serves to generate airflow, this airflow being adjacent to the upper side of the atomisation surface at the top of the device. The air enters the device through vents (24) in the outer casing (10) and, in passing through the device, passes through baffles (25), which serve to smooth the flow of the air over the atomisation surface (1).

All of the electrical power for the device is supplied by the battery (8), which can be accessed via a detachable plate (26) in the bottom section of the outer casing (10). Power supply from the battery (8) is activated by means of pressure switch (27). Control circuitry, not shown, connects all the electrical components of the device. When the device is activated by pressing switch (27), power is supplied from the battery (8) and the electrical valve (21) is opened, the piezoelectric discs (4A, 4B) are activated, and the fan motor (23) is activated.

FIG. 8 shows the atomisation surface (2), which has a regular array of tessellating hexagonal cross-section hollows upon it. Opening into the centre of the atomisation surface is the transfer conduit (19).

Experiments

Various atomisation surfaces were tested. Acoustic vibration was provided by a variable frequency signal generator (type J2B, Advance), together with a 120 watt amplifier (type Prism Audio MTK 150F), feeding in to a 300 watt loudspeaker (type Rc92, Delta 10A, 10 Inch PA driver), upon which the atomisation surfaces were placed. The quality of the spray produced was analysed using a Malvern 2600 laser diffraction instrument.

Table 1 gives spray data generated from atomisation surfaces having hollows having flat bottoms, perpendicular sides, and hexagonal cross-sections, as illustrated in FIG. 3. The hexagonal hollows of each atomisation surface were of the same dimensions, these also being indicated in Table 1. The hollows were kept full of the indicated liquid during the course of the experiments.

TABLE 1
Examples 1 to 6

| | Acoustic | Hexagonal hollow | | | Spray quality | |
|---|---|---|---|---|---|---|
| | Frequency | dimensions (mm) | | Liquid | D4.3 | |
| Example | (KHz) | side | depth | atomised | (μ) | SPAN |
| 1 | 5 | 2.5 | 1.5 | Water | 138.5 | 0.36 |
| 2 | 5 | 2.5 | 1.5 | Ethanol | 113.2 | 0.46 |
| 3 | 5.5 | 2.5 | 1.5 | Water | 150.8 | 0.51 |
| 4 | 5.5 | 2.5 | 1.5 | Ethanol | 138.6 | 0.68 |
| 5 | 6.5 | 5.0 | 1.5 | Water | 49.6 | 0.70 |
| 6 | 6.5 | 5.0 | 1.5 | Ethanol | 82.6 | 0.82 |

Table 1 indicates good quality spray generation (note, in particular, the low SPAN values) at relative low acoustic frequencies. In a comparative experiment, the spray quality from a commercially available Lechler ultrasonic atomiser (US2710) was measured. At an acoustic frequency of 58 KHz the spray produced had a D4,3 of 97.0μ and a SPAN of 1.37—i.e. lower quality than the Examples according to the invention, despite the significantly higher acoustic frequency used.

Table 2 gives spray data generated from atomisation surfaces having hollows of rectangular cross-section in the form of a series of parallel slots, in the manner illustrated in FIG. 5. The hollows of each atomisation surface were of the same dimensions. Examples 7 and 8 were performed on an atomisation surface having 12 parallel slots of 20 mm length, separated by from one another by gaps of 1.5 mm. Examples 9 to 11 were performed on an atomisation surface having 20 parallel slots of 34 mm length, separated by from one another by gaps of 1.5 mm. The width and depth of the slots are indicated in the Table. The surfaces were kept supplied with the indicated liquid by dropwise addition from the top at a rate of 5 ml/min. for examples 7, 8 and 11 and at a rate of 12 ml/min. for examples 9 and 10.

TABLE 2
Examples 7 to 11

| | Acoustic | Rectangular slot | | | Spray quality | |
|---|---|---|---|---|---|---|
| | Frequency | dimensions (mm) | | Liquid | D4.3 | |
| Example | (KHz) | width | depth | atomised | (μ) | SPAN |
| 7 | 7.5 | 0.2 | 3 | Water | 88.5 | 1.19 |
| 8 | 6.0 | 0.2 | 3 | Ethanol | 100.8 | 1.39 |
| 9 | 7.0 | 0.15 | 4 | Ethanol | 33.2 | 0.91 |
| 10 | 5.0 | 0.15 | 4 | Water | 51.8 | 0.71 |
| 11 | 5.0 | 0.15 | 4 | GS¹ | 160.2 | 0.83 |

¹Glycerol solution of concentration 76% by weight.

Significantly, no atomisation could be obtained at the frequencies indicated with flat atomisation surfaces.

The examples of Table 2 further illustrate the good quality atomisation that may be achieved by use of the present invention.

Example 11 illustrates that even viscous compositions may be atomised by use of the present invention.

1. A method of generating a spray comprising subjecting a liquid on a continuous atomisation surface to acoustic vibration, characterised in that the continuous atomisation surface comprises multiple hollows from which the liquid is atomised.

2. A method according to claim 1, wherein the multiple hollows cover 50% or greater of the atomisation surface.

3. A method according to claim 1, wherein the depth of each hollow is 5 mm or less.

4. A method according to claim 1, wherein the hollows tessellate.

5. A method according to claim 1, wherein the hollows have the same cross-sectional shape.

6. A method according to claim 1, wherein the continuous atomisation surface comprises multiple hollows having hexagonal cross-sectional shape.

7. A method according to claim 1, wherein the continuous atomisation surface comprises multiple hollows having square cross-sectional shape.

8. A method according to claim 2, wherein the hollows cover 90% or greater of the atomisation surface.

9. A method according to claim 1, wherein the hollows have-vertical walls.

10. A method according to claim 1, wherein the hollows have flat bottoms.

11. A method according to claim 1, wherein the liquid to be atomised is present in the hollows at an amount of 50% or greater of the volume of the hollows.

12. A method according to claim 1, wherein the acoustic vibration is at frequency of from 2 to 55 KHz.

13. A method according to claim 1, for the generation of a spray in the domestic environment.

14. A method according to claim 12, for the generation of a cosmetic spray.

15. A method according to claim 14, for the generation of a deodorant spray.

16. A spray device comprising a continuous atomisation surface, a reservoir for holding the liquid to be atomised, means for transferring the liquid from the reservoir to the atomisation surface, and means for subjecting the continuous atomisation surface to acoustic vibration, characterised in that the continuous atomisation surface comprises multiple hollows from which the liquid is atomised.

17. A spray device according to claim 16, wherein the means for subjecting the liquid to acoustic vibration comprises an acoustic vibrator which is in contact with the underside of the atomisation surface and a control means for activating the acoustic vibrator.

18. A spray device according to claim 16, wherein the continuous atomisation surface comprises multiple hollows having a hexagonal cross-section.

19. A spray device according to claim 16, wherein the continuous atomisation surface comprises hollows in the form of slots or grooves.

20. A spray device according to claim 16, wherein the means for delivering a liquid to the atomisation surface enables supply of the liquid from the underside of said atomisation surface.

21. A spray device according to claim 16, comprising a means of generating airflow adjacent to the upper side of the atomisation surface.

22. A product comprising a spray device according claim 16 and a liquid cosmetic composition for spraying therefrom.

23. A product according to claim 22 wherein the liquid cosmetic composition has a viscosity of equal to or greater than 10 mm^{2/}s.
